(19) United States
(12) Patent Application Publication
(10) Pub. No.: US 2006/0039622 A1
(43) Pub. Date: Feb. 23, 2006

(54) Sharpness enhancement

(75) Inventors: Carlo Casale, Busto Arsizio (NL); Denis De Monte, Forni Di Sotto ( Udine) (IT); Luigi Albani, Merate (IT); Giovanni Ramponi, Trieste (IT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/531,941

(22) PCT Filed: Sep. 22, 2003
(86) PCT No.: PCT/IB03/04318

§ 371 Date: Apr. 19, 2005

(30) Foreign Application Priority Data
Oct. 23, 2002 (EP) 02079420.2

(51) Int. Cl. G06K 9/40

(52) U.S. Cl. 382/266; 348/625

(57) ABSTRACT

A two-dimensional enhancement function (HEF; VEF) determines a peaking factor (CX; CY) for an input signal (L(m,n)) based on the output signals of both a first edge detector (HHP; VHP) and a second edge detector (HBP; VBP) which both operate in the same first spatial direction. In this manner, all different kind of borders which may occur in the input signal (L(m,n)) in the first spatial direction are distinguished. The two-dimensional enhancement function (HEF; VEF) allocates values which determine the amount of peaking to the different combinations of the output signals (ZX, DX; ZY, DY). It is possible to select the values allocated by the two-dimensional enhancement function (HEF; VEF) different for different kind of borders to obtain the desired amount of peaking fitting each kind of border best.

The invention relates to a method of sharpness enhancement, a sharpness enhancement circuit, and a display apparatus comprising such a sharpness enhancement circuit.

The invention is particularly relevant for still image and video sequence sharpness enhancement on matrix displays such as for example Liquid Crystal Displays (LCDs) or Organic Light Emitted Diodes (OLEDs).

WO-A-00/42772 discloses a method of sharpness enhancement by adding an overshoot to luminance edges in an “unsharp masking like manner”. The amount of overshoot added depends on local image statistics.

The method uses a spatial horizontal high-pass filter which filters the input image signal in the horizontal direction to obtain a horizontal high-pass filtered input image signal. The input image signal may comprise a still picture or moving video, or a combination of both. The method further uses a spatial vertical high-pass filter which filters the input image signal in the vertical direction to obtain a vertical high-pass filtered input image signal. The horizontal high-pass filtered input image signal is multiplied with a horizontal peaking factor to obtain a horizontally peaked image signal. The vertical high-pass filtered input image signal is multiplied with a vertical peaking factor to obtain a vertically peaked image signal. The horizontally peaked image signal and the vertical peaked image signal are added to obtain the peaked image signal.

The method of generating the horizontal peaking factor is elucidated in the now following; the vertical peaking factor is determined in the same way. A band-pass filter filters the input signal in the horizontal direction to obtain a band-pass filtered input signal. A non-linear function converts the band-pass filtered input signal into a control signal which has values depending on the amplitude of the band-pass filtered input signal. In a parallel step, based on both the horizontal high-pass filtered input image signal and the vertical high pass filtered input image signal, a thin-line-enhancement circuit detects whether a horizontal, a vertical, or a diagonal thin line is present. An over-peaking control function supplies a thin line control signal based on the thin line detected. If a thin line is detected, the thin line control signal is supplied via a low pass filter as the horizontal peaking factor. If no thin line is detected, the control signal supplied by the non-linear function is supplied via the low pass filter as the horizontal peaking factor.

A drawback of this sharpness enhancement method is that despite the presence of the thin line enhancement circuit, the sharpness enhancement will be too strong for sharp edges and edges with overshoot.

It is an object of the invention to provide an improved sharpness enhancement.

A first aspect of the invention provides a method of sharpness enhancement as claimed in claim 1. A second aspect of the invention provides a sharpness enhancement circuit as claimed in claim 19. A third aspect of the invention provides a display apparatus as claimed in claim 20. Advantageous embodiments are defined in the dependent claims.

There is presently an increasing interest in image and video sequence sharpness enhancement processing in PC-displays and television displays (LCD TV, plasma TV etc.). This is in particular true for applications wherein a local area of the screen is highlighted, for example to increase the visibility of details and/or to improve the contrast. Several algorithms have been developed for Cathode Ray Tubes or TV apparatus but their effectiveness drops in case of LCD's or other matrix displays (such as for example, Plasma Display Panels, Organic Light Emitted Diodes), which have quickly penetrated the market. The main reason of the low effectiveness is the high level of contrast and the different aperture characteristics in the matrix display systems, which make any artifact of the enhancement algorithms more visible.

In the method of sharpness enhancement in accordance with the first aspect of the invention, a peaking function which is a two-dimensional enhancement function determines the peaking factor based on both a first edge detector signal and a second edge detector signal both operating in the same spatial direction. The use of two different edge detectors allows detecting more different kind of edges. The two-dimensional enhancement function generates the peaking factor having values which depend on both the value of the first edge detector signal and the second edge detector signal.

Preferably, the detectors are selected such that sufficient information is obtained to distinguish all different kinds of borders which may occur in the input image in the particular spatial direction, such as for example, a slowly ramping edge, a smoothly curving edge, a sharp edge, an edge with overshoot, and a thin line. Because, based on the different combinations of the first edge detector signal and the second edge detector signal it is possible to detect more different kinds of borders than in the prior art, the peaking of the different borders is improved.

In an embodiment as defined in claim 2, a peaking function which is a two-dimensional enhancement function determines the peaking factor based on both a high-pass filtered input image signal and a band-pass filtered input image signal.

It appeared that the output signals of the high-pass filter and the band-pass filter together provide sufficient information to distinguish all different kinds of borders which may occur in the input image, such as for example, a slowly ramping edge, a smoothly curving edge, a sharp edge, an edge with overshoot, and a thin line. The two-dimensional enhancement function allocates values which determine the amount of peaking to the different combinations of the high-pass filtered input image signal and the band-pass filtered input image signal. Because, based on the different combinations of the high-pass filtered input image signal and the band-pass filtered input image signal it is possible to detect all different kinds of borders, it is possible to select the values allocated by the two-dimensional enhancement function different for different kind of borders to obtain the desired amount of peaking fitting each kind of border best.

This allows obtaining a level of sharpness enhancement comparable with the prior art algorithm, while adding the following improvements. The discontinuity of the treatment in the enhancement of thin lines and smooth or sharp edges is minimized. The excessive overshoot inserted by the other algorithms on real images already processed by some peaking algorithm or filter (causing edges with overshoot) is limited. And, the visibility of the “staircase effect” in diagonal thin lines after the enhancement processing is limited.

In an embodiment as defined in claim 3, the high-pass filtering and the band-pass filtering is performed on the horizontal component of the input image signal which usually is the direction in which the lines of pixels extend which are addressed line by line. The horizontal enhancement function provides output values for a horizontal peaking factor. The output values depend on input combinations of the values of the horizontal high-pass filtered signal and the horizontal band-pass filtered signal.

In an embodiment as defined in claim 4, the horizontal enhancement function has values which allow an optimal sharpness enhancement in the horizontal direction also for sharp edges, edges which have already overshoot, and thin lines.

In an embodiment as defined in claim 5, further, vertical high-pass filtering and vertical band-pass filtering is performed on the vertical component of the input image signal which usually is the direction in which the lines of the input image signal succeed each other. The vertical enhancement function provides output values for a vertical peaking factor to input combinations of the values of the vertical high-pass filtered signal and the vertical band-pass filtered signal. Now, the sharpness improvement is optimized in both the horizontal and the vertical direction.

In an embodiment as defined in claim 6, the vertical enhancement function has values which allow an optimal sharpness enhancement in the vertical direction for sharp edges, edges which have already overshoot, and thin lines.

In an embodiment as defined in claim 7, a horizontal correction factor is obtained by multiplying the horizontal high-pass filtered signal with the horizontal peaking factor, and a vertical correction factor is obtained by multiplying the vertical high-pass filtered signal with the vertical peaking factor. A total correction factor is a sum of the horizontal correction factor and the vertical correction factor. The sharpness enhancement of the input image signal is obtained by adding the total correction factor to the input image signal.

In an embodiment as defined in claim 8, the total correction factor is a weighted sum of the horizontal and the vertical correction factor. The weighting factor of the horizontal correction factor depends on the value of the vertical correction factor and the other way around. If the value of the vertical correction factor becomes larger than a predetermined threshold level, the horizontal weighting factor decreases. In the same manner, if the value of the horizontal correction factor becomes larger than a predetermined threshold level, the vertical weighting factor decreases. This has the advantage that excessive enhancement in corners and on isolated pixels is avoided.

In an embodiment as defined in claim 9, the horizontal and/or vertical enhancement function are/is modified dependent on the level of noise in the input image signal. This has the advantage that the amount of peaking is dependent on the amount of noise detected. At high levels of noise, the amount of peaking decreases to lower the visibility of the noise.

In an embodiment as defined in claim 16, two high-pass filters operating on samples of the input signal in a first spatial direction are used as edge detectors.

In an embodiment as defined in claim 17, the first spatial direction is the horizontal direction. Although the subject matter claimed in claim 17 is directed towards the peaking of the input signal in the first spatial direction only, it is possible to perform an additional peaking of the input signal in a second spatial direction which usually is the vertical direction. Preferably, the two high-pass filters used in the vertical direction are identical to the two high-pass filters used in the horizontal direction.

These and other aspects of the invention are apparent from and will be elucidated with reference to the embodiments described hereinafter.

In the drawings:

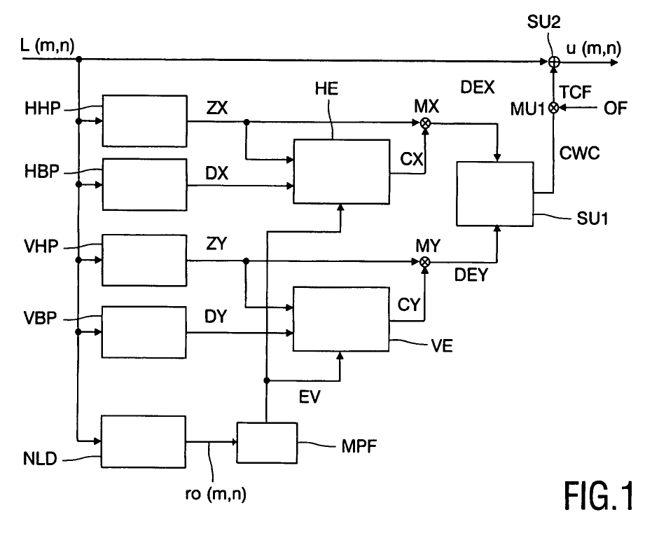

FIG. 1 shows a block diagram of a sharpness enhancement circuit in accordance with an embodiment of the invention,

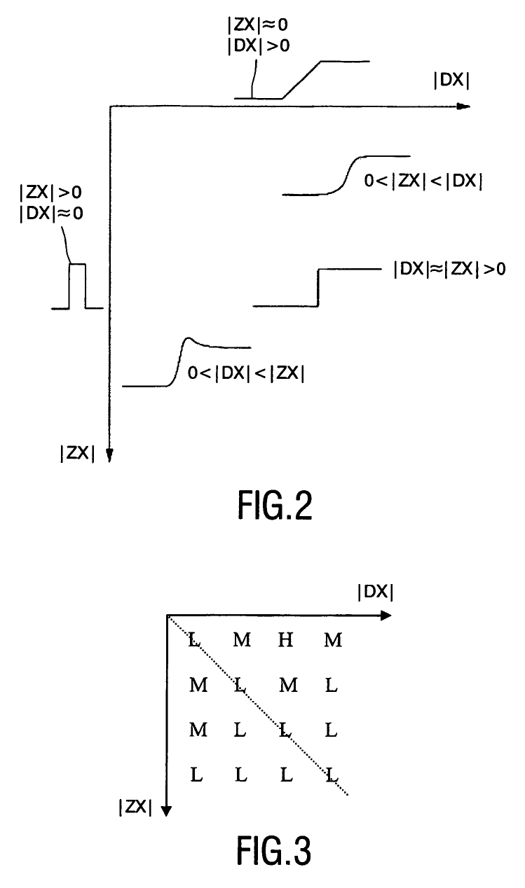

FIG. 2 shows a schematic representation indicating which kind of edges are related to which combinations of the high-pass filtered and the band-pass filtered input image signals,

FIG. 3 shows a schematic distribution of values of the two dimensional enhancement function,

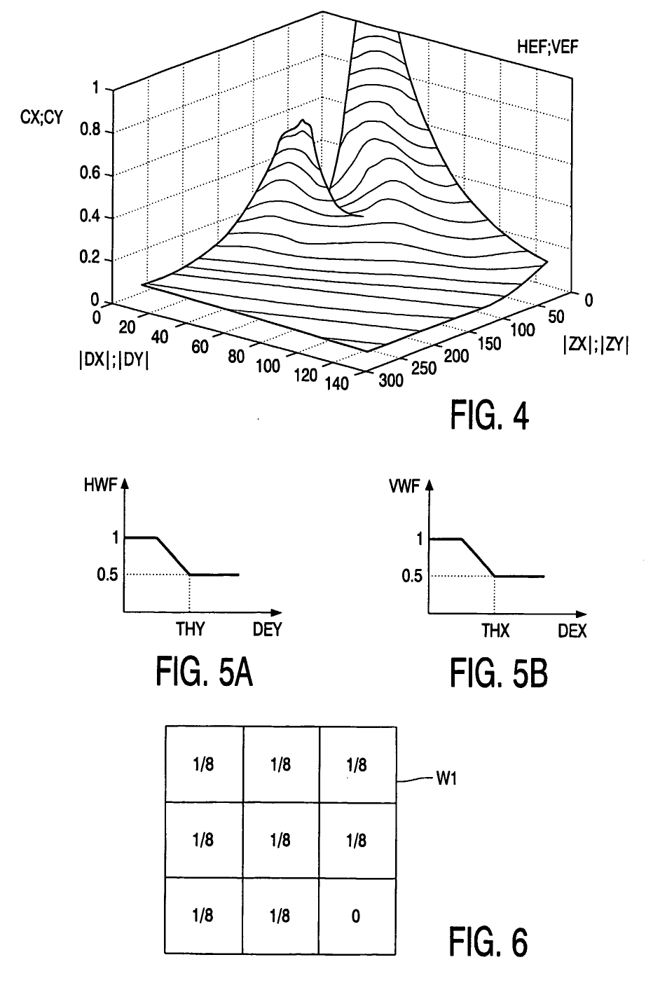

FIG. 4 shows an embodiment of the two dimensional enhancement function,

FIG. 5 shows weighting coefficients for summing the horizontal and the vertical correction factors,

FIG. 6 shows an embodiment of a convolution mask for approximating the average value of the luminance used to estimate a standard deviation of the noise level in the input image signal,

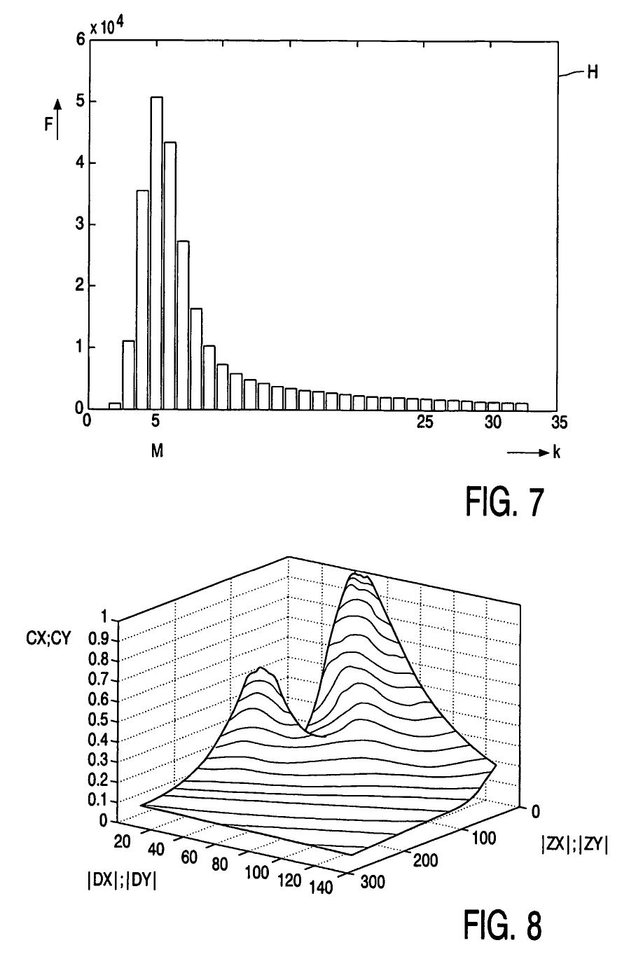

FIG. 7 shows an example of a histogram of the estimates of the standard deviation,

FIG. 8 shows an embodiment of the two dimensional enhancement function for a noisy input image signal, and

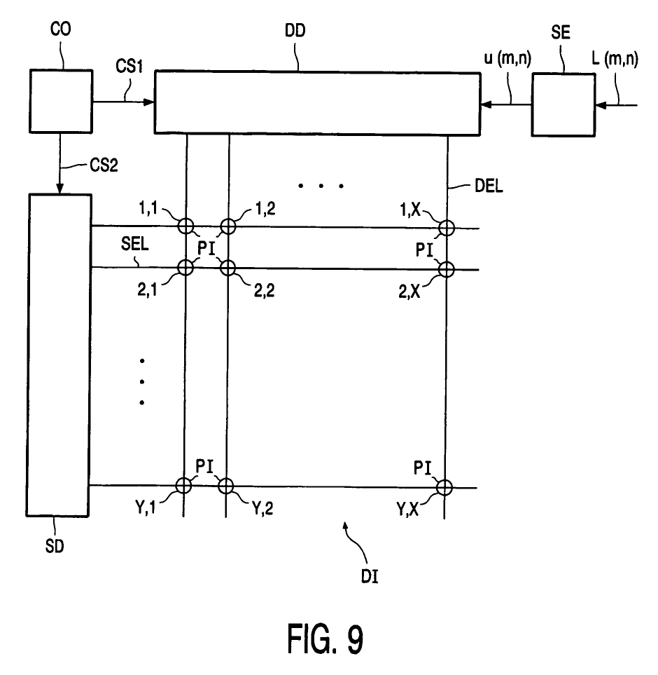

FIG. 9 shows an embodiment of a matrix display apparatus with a sharpness enhancement circuit in accordance with the invention.

The same references in different Figs. refer to the same signals or to the same elements performing the same function.

FIG. 1 shows a block diagram of a sharpness enhancement circuit in accordance with an embodiment of the invention.

The input image signal L(m,n) is to be displayed on a matrix display DI (see FIG. 9) which has a number of display pixels (display elements) in the horizontal direction (indicated by n) equal to X, and a number of pixels in the vertical direction (indicated by m) equal to Y. An input image pixel (video pixel to be displayed on a display pixel) belonging to the input image signal L(m,n) is indicated by a set of integer numbers m and n, wherein 1≦m≦Y and 1≦n≦X.

As a particular video pixel should be displayed on the corresponding display pixel, in the following the term pixel is used for both the video and the display pixel.

The input image signal L(m,n) represents a quantity related to the Luminance of the pixel located in position (m,n). For example, L(m,n) is calculated with the following formula: L(m,n)=0.289 R(m,n)+0.597 G(m,n)+0.114 B(m,n), wherein R(m,n), G(m,n), B(m,n) are the Red, Green and Blue Luminance values of the pixel m,n normalized to one, respectively.

A horizontal high-pass filter HHP filters the input image signal L(m,n) to obtain a horizontal high-pass filtered signal ZX, hereinafter also indicated with ZX(m,n). A horizontal band-pass filter HBP filters the input image signal L(m,n) to obtain a horizontal band-pass filtered signal DX, hereinafter also indicated with DX(m,n). A horizontal enhancement function circuit HE performs a horizontal enhancement function HEF (see FIGS. 4 and 8) which converts the horizontal high-pass filtered signal ZX and the horizontal band-pass filtered signal DX into a horizontal peaking factor CX. For each value of the input image signal L(m,n), the horizontal peaking factor CX is a value which is based on the value of both the horizontal high-pass filtered signal ZX and the horizontal band-pass filtered signal DX. The multiplier MX multiplies the horizontal peaking factor CX with the horizontal high-pass filtered signal ZX to obtain a horizontal correction factor DEX.

A vertical high-pass filter VHP filters the input image signal L(m,n) to obtain a vertical high-pass filtered signal ZY, hereinafter also referred to as ZY(m,n). A vertical band-pass filter VBP filters the input image signal L(m,n) to obtain a vertical band-pass filtered signal DY, hereinafter also referred to as DY(m,n). A vertical enhancement function circuit VE performs a vertical enhancement function VEF (see FIGS. 4 and 8) which converts the vertical high-pass filtered signal ZY and the vertical band-pass filtered signal DY into a vertical peaking factor CY. For each value of the input image signal L(m,n), the vertical peaking factor CY is a value which is based on the value of both the vertical high-pass filtered signal ZY and the vertical band-pass filtered signal DY. The multiplier MY multiplies the vertical peaking factor CY with the vertical high-pass filtered signal ZY to obtain a vertical correction factor DEY.

An adder SU1 adds the horizontal correction factor DEX and the vertical correction factor DEY to obtain a total correction factor CWC. Preferably, the summing is performed by using weighting factors. The horizontal correction factor DEX is multiplied by a horizontal weighting factor and the vertical correction factor DEY is multiplied by a vertical weighting factor, and the multiplied correction factors are summed.

A multiplier MU1 multiplies the total correction factor CWC with a control value OF which determines the overall amount of peaking to obtain the correction factor TCF. The control value OF may be set by a user to control the amount of peaking to his liking.

An adder SU2 sums the correction factor TCF to the input image signal L(m,n) to obtain the output signal u(m,n) which is the peaking enhanced input image signal L(m,n).

The optional noise estimator NLD estimates the level of noise in the input image signal L(m,n) to obtain an estimated standard deviation of the noise ro(m,n). The modifying circuit MPF supplies a control signal EV to the horizontal enhancement function circuit HE and to the vertical enhancement function circuit VE to modify the horizontal enhancement function HEF and the vertical enhancement function VEF dependent on the amount of noise detected. It is possible to modify the horizontal enhancement function HEF and the vertical enhancement function VEF differently in response to the amount of noise detected.

In a preferred embodiment, the high-pass filters in horizontal and vertical directions are realized with the following filters:
ZX(m, n)=2L(m, n)−L(m, n−1)−L(m, n+1)
ZY(m, n)=2L(m, n)−L(m−1, n)−L(m+1, n)
   and the band-pass filters are realized as:
DX(m, n)=L(m, n+1)−L(m, n−1)
DY(m, n)=L(m+1, n)−L(m−1, n)

The enhancement function circuits HE, VE preferably are two-dimensional rational function blocks.

For simplicity, in the following, the operation of the sharpness enhancement circuit will be described in the horizontal direction only. Preferably, the sharpness enhancement is performed in the vertical direction also. The operation of the sharpness enhancement circuit in the vertical direction is carried out in the same way as in the horizontal direction.

The absolute values |DX| and |ZX| of the filtered signals DX an ZX are used to distinguish the different kinds of edges occurring in the input image signal L(m,n). If used alone, the high-pass filtered signal ZX does not allow to distinguish between a thin line (line having a thickness of one pixel) and a sharp edge or an edge with overshoot since its values will be high in all the mentioned cases. In the same manner, the band-pass filtered signal DX does not provide information on the occurrence of thin lines because its output will be about zero for thin lines. With the combination of both the high-pass filtered signal ZX and the band-pass filtered signal DX, it is possible to distinguish between smooth edges, sharp edges, thin lines and edges with overshoot as shown in FIG. 2.

Instead of a high-pass filter HHP and a band-pass filter HBP, it is possible to use other edge detectors. For example, the other edge detectors are two high-pass filters HHP and HBP which operate in the horizontal spatial direction and which are defined by:
ZX=L(m,n−1)−L(m,n)
DX=L(m,n)−L(m,n+1)
   Again it is possible to detect all edges occurring in the horizontal direction as is elucidated in the now following.
   A thin line in the horizontal direction is detected if
   |ZX|≅|DX| and ZX>0 and DX<0, or
   |ZX|≅|DX| and ZX<0 and DX>0.
   A steep edge is detected if
   |ZX|=high and |DX|=low, or
   |ZX|=low and |DX|=high.
   A smooth edge in the horizontal direction is detected if
   |ZX|≅|DX| and ZX>0 and DX>0, or
   |ZX|≅|DX| and ZX<0 and DX<0.
   An edge with overshoot in the horizontal direction is detected if
   |ZX|=high and |DX|=medium, and ZX>0 and DX<0, or
   |ZX|=high and |DX|=medium, and ZX<0 and DX>0.
   The criteria for defining the two-dimensional horizontal enhancement function HEF are similar to those used for the edge sensors already described (the high-pass filter and the band-pass filter).

In a same way, two corresponding high-pass filters may be used both operating in the vertical direction.

FIG. 2 shows a schematic representation indicating which kind of edges are related to which combinations of the high-pass filtered and the band-pass filtered input image signals. The vertical axis represents the absolute value |ZX| of the high-pass filtered input image signal ZX, and the horizontal axis represents the absolute value |DX| of the band-pass filtered input image signal DX. The absolute values |ZX| and |DX| for the rising edges shown in FIG. 2 and for the corresponding falling edges (not shown) are identical.

For a smooth edge, the value of |ZX| is small and the value of |DX| is high, which is indicated in FIG. 2 by 0<|ZX|<|DX|. For a sharp edge, the values of both |ZX| and |DX| are high and can be equal or almost equal, which is indicated in FIG. 2 by |ZX|≅|DX|. A thin line is characterized by a small value of the |DX| and a high value of |ZX|, which is indicated in FIG. 2 by |ZX|>0 and |DX|=0. The edge with overshoot has a high value of |ZX| and an average value of |DX|, which is indicated in FIG. 2 by 0<|DX|<|ZX|.

Thus, with the values |ZX| and |DX| it is possible to detect every possible configuration of edges. In the preferred embodiment of the invention, the values |ZX| and |DX| are determined by using the equations defined earlier. This means that only values of pixels in a 3-pixel window (the pixel values L(m−1,n), L(m,n), L(m+1,n)) have to be used.

Now it is possible to distinguish between all the possible edges depending on the position in the |ZX| and |DX| plane, it is possible to assign different values to the peaking factor CX depending on the position in the |ZX| and |DX| plane.

FIG. 3 shows a schematic distribution of values of the two dimensional enhancement function.

The rational function used in the publication “Picture enhancement in video and block-coded image sequences”, IEEE Trans. on Consumer Electronics, vol. 45, no. 3, pp. 680-689, August 1999, by G. Scognamiglio et al, shows a good performance with respect to both the noise sensitivity and excessive overshoots of the smooth edges.

In a preferred embodiment in accordance with the invention, the two dimensional enhancement function HEF along the |DX| axis is selected to be the rational function of the prior art. Further, thin lines should be processed in a similar manner as the smooth edges in order to prevent both excessive noise amplification and loss of details caused by clipping of luminance values, which occurs for highly contrasted thin lines. In this case, (i.e. along the |ZX| axis) a rational function with different parameters than that of the prior art has to be used in order to provide improved results.

The step edge should be less enhanced than the thin lines because the step edge often occurs on pixels adjacent to thin lines not perfectly horizontal or vertical and an excessive enhancement is the main cause of the “staircase effect” in digital images.

In the case of an edge with overshoot we want to maintain a very low level of enhancement to avoid a too luminous border that might appear in this situation. This drawback is particularly noticeable for images and video sequences with edges that are already enhanced with overshoot probably due to a post-processing in the acquisition stage.

In this case a further sharpness enhancement processing may be harmful because it may emphasize overshoots and make the image unnatural. The map shown in FIG. 3 shows an embodiment of the desired level of sharpness enhancement depending on the values of |DX| and |ZX|. The L letter identifies areas in the |DX| and |ZX| plane where the sharpness enhancement should be low, M identifies areas where the sharpness enhancement will be medium, and H identifies areas where the sharpness enhancement will be high.

FIG. 4 shows an embodiment of the two-dimensional enhancement function.

In a preferred embodiment, the two-dimensional enhancement function HEF is continuous over the whole |DX| and |ZX| plane. The value of the function HEF is close to zero near to the origin to avoid noise amplification and decreases for high values of |DX| and |ZX| in order to avoid extra emphasis on already well visible edges. The two-dimensional enhancement function HEF shown in FIG. 4 is an example of the implementation of the distribution of the values shown in FIG. 3, other non-linear functions implementing the basic distribution shown in FIG. 3 may be used.

The two-dimensional enhancement function may be realized by a Look-Up Table (LUT) which stores values which may be a uniform or non-uniform sampling of the continuous function. The output value of CX is obtained by means of a bilinear interpolator of the stored (sampled) values.

FIG. 5 show weighting coefficients for summing the horizontal and the vertical correction factors.

FIG. 5A shows the horizontal weighting function HWF as function of the vertical correction value DEY. In the embodiment shown, the horizontal weighting function HWF starts with a value 1 for low values of the vertical correction value DEY. The horizontal weighting function HWF decreases linearly from a predetermined value of the vertical correction value DEY to reach the value 0.5 at a vertical threshold value THY. The horizontal weighting function HWF keeps the value 0.5 for values of the vertical correction value DEY higher than the vertical threshold value THY.

FIG. 5B shows the vertical weighting function VWF as function of the horizontal correction value DEX. In the embodiment shown, the vertical weighting function VWF starts with a value 1 for low values of the horizontal correction value DEX. The vertical weighting function VWF decreases to reach the value 0.5 at a horizontal threshold value THX. And the vertical weighting function VWF keeps the value 0.5 for values of the horizontal correction value DEX higher than the horizontal threshold value THX.

The horizontal correction value DEX multiplied by the horizontal weighting function HWF and the vertical correction value DEY multiplied by the vertical weighting function VWF are summed. Consequently, if the vertical correction factor DEY is larger than a vertical threshold value THY, the horizontal weighting function HWF is smaller and the contribution of the horizontal correction value DEX will be reduced in order to avoid an excessive enhancement in corners and on isolated pixels. In this way it is possible to limit the visibility of noise. It is not necessary that the horizontal weighting factor and the vertical weighting factor are identical.

FIG. 6 shows an embodiment of a convolution mask for approximating the average value vgl(m,n) of the input signal L(m,n). This average value vgl(m,n) is used to estimate a standard deviation ro(m,n) of the noise level in the input signal L(m,n).

A noise estimator NLD evaluates the noise level present in the input image signal L(m,n). The two-dimensional enhancement functions HEF and VEF are modified based on the estimated noise level in order to avoid the enhancement of noise.

For example, the standard deviation ro(m,n) of the level of noise may be estimated according to:

$$ro ( m , n ) = 1 / 8 {\sum }_{i = - 1}^{1} {\sum }_{j = - 1}^{1} \vert L ( m + i , n + j ) - vgl ( m , n ) \vert$$

wherein vgl(m,n) is an approximation of an average value of the luminance values of the pixels PI in a 3 by 3 pixels window of which the centre is the pixel PI at the position m,n.

The average value vgl(m,n) may be determined by vgl(m,n)=L(m,n)**W1, wherein ** denotes a convolution, and W1 is a convolution mask indicating a weighting factor for each of the pixels PI in the 3 by 3 pixel window. FIG. 6 shows an embodiment of the convolution mask W1.

FIG. 7 shows an example of a histogram of the estimates of the standard deviation.

In the embodiment shown in FIG. 7, the histogram of the standard deviation ro(m,n) of the level of noise is calculated with the following expression:

$$h ( k ) = \begin{matrix}( i ) & \vert \{ ( m , n ) \vert k - 1 / 2 <= ro ( m , n ) < k + 1 / 2 \} \vert & if k = 1 , 2 , … , k max \\ ( ii ) & 2 \vert \{ ( m , n ) \vert 0 <= ro ( m , n ) < 1 / 2 \} \vert & if k = 0 , \end{matrix}$$

wherein |{ . . . }| denotes the number of elements of the set { . . . }.

In this embodiment of the histogram, kmax=32.

The estimated value for the standard deviation of the noise ro(m,n) is the mode parameter of the histogram (in the following referred to as M) i.e. the value of k corresponding to the histogram's peak. For example, FIG. 7 shows a histogram of an image with added noise, wherein the standard deviation of the noise is 5, and the value of the mode parameter M is 5. The value of M is used to control the two-dimensional enhancement functions HEF and/or VEF.

FIG. 8 shows an embodiment of the two-dimensional enhancement function for a noisy input image signal.

In a preferred embodiment, the two-dimensional function HEF, VEF shown in FIG. 4 is used for input image signals L(m,n) with a value of the parameter M lower than a predetermined value Mmin, and the two-dimensional function HEF, VEF depicted in FIG. 8 is used for input image signals L(m,n) with a value of the parameter M which is larger than a predetermined value Mmax. The two-dimensional function HEF, VEF of FIG. 8 is shifted toward higher values of |DX| and |ZX|, and its band, i.e. the range where the two-dimensional function HEF, VEF assumes the maximal value, is reduced with respect to the two-dimensional function HEF, VEF of FIG. 4. For intermediate values of M (i.e. Mmin<M<Mmax) the peaking factor CX is determined by interpolating the corresponding values of the two-dimensional functions shown in FIG. 4 and FIG. 8.

Mathematically, in a preferred embodiment, for each pixel PI, the value of the peaking factor CX is obtained as:
CX1(m,n) if M≦Mmin
   CX(m,n)=CX2(m,n) if M≦Mmax
CX1(m,n)+(CX2(m,n)−CX1(m,n)*(M−Mmin)/(Mmax−Mmin) for other values of M. Wherein CX1(m,n) is the value of the two-dimensional function HEF, VEF shown in FIG. 4, and CX2(m,n) is the value of the two-dimensional function HEF, VEF shown in FIG. 8, for |ZX|=|ZX(m,n)| and |DX|=|DX(m,n)|.

FIG. 9 shows an embodiment of a matrix display apparatus with a sharpness enhancement circuit in accordance with the invention.

The matrix display apparatus comprises a matrix display DI with an array of pixels PI which are associated with intersections of crossing select electrodes SEL and data electrodes DEL. The matrix display DI has X pixels in the direction of the select electrodes SEL which usually extend in the horizontal direction, and Y pixels in the direction of the data electrodes DEL which usually extend in the vertical direction. The position of the pixels PI in the matrix display DI is indicated with two numbers m,n which run from 1, 1 for the top left pixel PI to Y, X for the bottom right pixel PI. The number m indicates the position along the data electrodes DEL, thus in this embodiment the vertical position. The number n indicates the position along the select electrodes SEL, thus in this embodiment the horizontal direction.

A select driver SD supplies select signals to the select electrodes SEL. A data driver DD supplies data signals to the data electrodes DEL. A controller CO supplies a control signal CS1 to the data driver DD and a control signal CS2 to the select driver SD. Usually, the controller CO controls the select driver SD to select the pixels PI line by line, and the data driver to supply the appropriate data voltages in parallel to the selected line of pixels PI.

A sharpness enhancement circuit SE receives the input image signal L(m,n) and supplies the enhanced data signal u(m,n) to the data driver DD. The input image signal L(m,n) is a time discrete signal which has X samples per line and Y lines to fit the number of pixels PI of the matrix display DI. The samples of the input image signal L(m,n) are usually referred to as (video) pixels. The display pixels PI of the matrix display DI are usually referred to as pixels also. Thus, with pixels both the video and the display pixels may be indicated. The term L(m,n) is used both to indicate the input image signal and the luminance of the pixel PI at the position m,n. The meaning of the terms pixel and L(m,n) will be clear from the context.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer or a digital signal processor (DSP). In the device claim enumerating several means, several of these means can be embodied by one and the same item of hardware. The mere fact that certain measures are recited in mutually different dependent claims does not indicate that a combination of these measures cannot be used to advantage.

The invention provides a two-dimensional enhancement function which determines a peaking factor for an input signal based on the output signals of both a first edge detector and a second edge detector which both operate in the same first spatial direction. In this manner, all different kind of borders which may occur in the input signal in the first spatial direction are distinguished. The two-dimensional enhancement function allocates values which determine the amount of peaking to the different combinations of the output signals. It is possible to select the values allocated by the two-dimensional enhancement function different for different kind of borders to obtain the desired amount of peaking fitting each kind of border best.

To conclude, in a preferred embodiment of the invention, the method of sharpness enhancement uses a two-dimensional function controlled by a high-pass filter and a band-pass filter or equivalent detectors which are able to distinguish all edge configurations that occur in natural images: a smooth edge, a sharp edge, a thin line, and an edge with overshoot. The two-dimensional function allows to separately control the enhancement applied to the each one of the different kind of edges listed above. Further, preferably, the two-dimensional function is adapted dependent on the noise level of the input image signal. Preferably, the method of measuring the input image signal noise uses a histogram of standard deviation evaluated on a 3×3 pixel window.

1. A method of sharpness enhancement of an input signal comprising
detecting in a first spatial direction a first subset of edges in the input signal to obtain a first detector signal,
detecting in the first spatial direction a second subset of edges in the input signal to obtain a second detector signal, said second subset being different from the first subset,
determining a peaking factor by using a predetermined two-dimensional enhancement function allocating values for the peaking factor to combinations of values of the first detector signal and the second detector signal, and
multiplying the first detector signal with the peaking factor to obtain a peaked signal.

2. A method of sharpness enhancement as claimed in claim 1, wherein
the detecting the first subset of edges comprises high-pass filtering the input image signal to obtain a high-pass filtered signal,
the detecting the second subset of edges comprises band-pass filtering the input image signal to obtain a band-pass filtered signal,
the determining the peaking factor by using a predetermined two-dimensional enhancement function being adapted for allocating values for the peaking factor to combinations of values of the high-pass filtered signal and the band-pass filtered signal, and
multiplying the high-pass filtered signal with a multiplying factor based on the peaking factor.

3. A method of sharpness enhancement as claimed in claim 2, wherein
the high-pass filtering comprises horizontal high-pass filtering a horizontal component of the input image signal to obtain a horizontal high-pass filtered signal,
the band-pass filtering comprises horizontal band-pass filtering the horizontal component of the input image signal to obtain a horizontal band-pass filtered signal, and
the determining of the peaking factor comprises using a predetermined two-dimensional horizontal enhancement function for allocating values for a horizontal peaking factor to combinations of values of the horizontal high-pass filtered signal and the horizontal band-pass filtered signal.

4. A method of sharpness enhancement as claimed in claim 3, wherein said horizontal enhancement function has a relatively low value if
(i) a value of the horizontal high-pass filtered signal and a value of the horizontal band-pass filtered signal are substantially equal,
(ii) the value of the horizontal high-pass filtered signal is larger than a first predetermined value, or
(iii) the value of the horizontal band-pass filtered signal is larger than a second predetermined value, and
wherein, if (i) is not valid, said horizontal enhancement function has a relatively high value if:
(iv) the value of the horizontal high-pass filtered signal is smaller than the first predetermined value, or
(v) the value of the horizontal band-pass filtered signal is smaller than the second predetermined value.

5. A method of sharpness enhancement as claimed in claim 3, wherein the method further comprises
vertical high-pass filtering a vertical component of the input image signal to obtain a vertical high-pass filtered signal,
vertical band-pass filtering the vertical component of the input image signal to obtain a vertical band-pass filtered signal,
the determining of the peaking factor comprises using a predetermined two-dimensional vertical enhancement function for allocating values for a vertical peaking factor to combinations of values of the vertical high-pass filtered signal and the vertical band-pass filtered signal.

6. A method of sharpness enhancement as claimed in claim 5, wherein said vertical enhancement function has a relatively low value if
(i) a value of the vertical high-pass filtered signal and a value of the vertical band-pass filtered signal are substantially equal,
(ii) the value of the vertical high-pass filtered signal is relatively large, or
(iii) the value of the vertical band-pass filtered signal is relatively large, and wherein said vertical enhancement function has a relatively high value if
(iv) the value of the vertical high-pass filtered signal is relatively small and (i) is not valid, or
(v) the value of the vertical band-pass filtered signal is relatively small and (i) is not valid.

7. A method of sharpness enhancement as claimed in claim 5, wherein the multiplying comprises
multiplying the horizontal high pass filtered signal with the horizontal peaking factor to obtain a horizontal correction factor,
multiplying the vertical high pass filtered signal with the vertical peaking factor to obtain a vertical correction factor,
summing the horizontal correction factor and the vertical correction factor to obtain a total correction factor, and
summing the total correction factor to the input image signal.

8. A method of sharpness enhancement as claimed in claim 7, wherein the summing of the horizontal correction factor and the vertical correction factor comprises weighting the horizontal correction factor with a horizontal weighting factor, and the vertical correction factor with a vertical weighting factor, wherein the horizontal weighting factor has a lower value when the vertical correction factor surpasses a first threshold, and wherein the vertical weighting factor has a lower value when the horizontal correction factor surpasses a second threshold.

9. A method of sharpness enhancement as claimed in claim 7, wherein the method further comprises determining a level of noise being present in the input image signal, and modifying the horizontal peaking factor and/or vertical peaking factor in dependence on the level of noise in order to reduce an enhancement of noise.

10. A method of sharpness enhancement as claimed in claim 9, wherein the determining of the level of noise comprises estimating a standard deviation of the noise.

11. A method of sharpness enhancement as claimed in claim 3, wherein the input image signal represents an image formed by a matrix of pixels, a position of a pixel in the matrix being defined by indices m,n wherein the index n indicates a horizontal position and the index m indicates a vertical position, and wherein the horizontal high-pass filtering comprises Laplacian filtering defined by Zx(m,n)=2L(m,n)−L(m,n−1)−L(m,n+1), and wherein the horizontal band-pass filtering comprises filtering defined by Dx(m,n)=L(m,n+1)−L(m,n−1), and wherein L(m,n) is related to the luminance of a pixel at position m,n, L(m,n−1) is related to the luminance of a pixel at position m,n−1, and L(m,n+1) is related to the luminance of a pixel at position m,n+1.

12. A method of sharpness enhancement as claimed in claim 5, wherein the input image signal represents an image being formed by a matrix of pixels, a position of a pixel in the matrix being defined by indices m,n wherein the index n indicates a horizontal position and the index m indicates a vertical position, and wherein the vertical high-pass filter comprises a Laplacian filter defined by Zy(m,n)=2L(m,n)−L(m'1,n)−L(m+1,n), wherein the vertical band-pass filter is a filter Dy(m,n)=L(m+1,n)−L(m−1,n), and wherein L(m,n) is related to the luminance of a pixel at position m,n, L(m−1,n) is related to the luminance of a pixel at position m−1,n, and L(m+1,n) is related to the luminance of a pixel at position m+1,n.

13. A method of sharpness enhancement as claimed in claim 10, wherein the estimating of the standard deviation comprises determining for each pixel for a 3 by 3 pixels window:
$$ro ( m , n ) = 1 / 8 {\sum }_{i = - 1}^{1} {\sum }_{j = - 1}^{1} \vert L ( m + i , n + j ) - vgl ( m , n ) \vert$$
wherein vgl(m,n) is an approximation of an average value of the luminance values of the pixels in the 3 by 3 pixels window.

14. A method of sharpness enhancement as claimed in claim 13, wherein the average value is determined by vgl(m,n)=L(m,n)**W1, wherein ** denotes a convolution, and W1 is a convolution mask indicating a weighting factor for each of the pixels in the 3 by 3 pixel window.

15. A method of sharpness enhancement as claimed in claim 14, wherein for each pixel a histogram is calculated with the following expression:
$$h ( k ) = \begin{matrix}\vert \{ ( m , n ) \vert k - 1 / 2 <= ro ( m , n ) < k + 1 / 2 \} \vert & if k = 1 , 2 , … , k max , or \\ 2 \vert \{ ( m , n ) \vert 0 <= ro ( m , n ) < 1 / 2 \} \vert & if k = 0 ,\end{matrix}$$
wherein |{ . . . }| denotes the number of elements of the set { . . . },
and wherein an estimated value for a standard deviation of the noise level is the value k=M corresponding to the highest value in the histogram, and wherein the horizontal peaking factor and the vertical peaking factor depend on said estimated value.

16. A method of sharpness enhancement as claimed in claim 1, wherein
the detecting the first subset of edges comprises high-pass filtering the input image signal to obtain a first high-pass filtered signal,
the detecting the second subset of edges comprises high-pass filtering the input image signal to obtain a second high-pass filtered signal,
the determining the peaking factor by using a predetermined two-dimensional enhancement function being adapted for allocating values for the peaking factor to combinations of values of the first high-pass filtered signal and the second high-pass filtered signal, and
multiplying the first high-pass filtered signal with the peaking factor.

17. A method of sharpness enhancement as claimed in claim 16, wherein
the first high-pass filtering comprises horizontal high-pass filtering a horizontal component of the input image signal to obtain a first horizontal high-pass filtered signal,
the second high-pass filtering comprises horizontal high-pass filtering the horizontal component of the input image signal to obtain a second horizontal band-pass filtered signal, and
the determining of the peaking factor comprises using a predetermined two-dimensional horizontal enhancement function for allocating values for a horizontal peaking factor to combinations of values of the first horizontal high-pass filtered signal and the second horizontal high-pass filtered signal.

18. A method of sharpness enhancement as claimed in claim 17, wherein the method further comprises
first vertical high-pass filtering a vertical component of the input image signal to obtain a first vertical high-pass filtered signal,
second vertical high-pass filtering the vertical component of the input image signal to obtain a second vertical band-pass filtered signal,
the determining of the peaking factor comprises using a predetermined two-dimensional vertical enhancement function for allocating values for a vertical peaking factor to combinations of values of the first vertical high-pass filtered signal and the second vertical high-pass filtered signal.

19. A sharpness enhancement circuit comprising
a first edge detector for detecting in a first spatial direction a first subset of edges in the input signal to obtain a first detector signal,
a second edge detector for detecting in the first spatial direction a second subset of edges in the input signal to obtain a second detector signal, said second subset being different from the first subset,
a means for determining a peaking factor by using a predetermined two-dimensional enhancement function allocating values for the peaking factor to combinations of values of the first detector signal and the second detector signal, and
a multiplier for multiplying the first detector signal with the peaking factor to obtain a peaked input signal.

20. A display apparatus comprising a matrix display and a sharpness enhancement circuit as claimed in claim 19.
